(19) United States
(12) Patent Application Publication
(10) Pub. No.: US 2004/0230354 A1
(43) Pub. Date: Nov. 18, 2004

(54) Automatic locomotive horn activation with intelligent sequencing

(75) Inventors: Scott A. Sollars, Marion, IA (US); Kevin J. Angel, Marion, IA (US)

Correspondence Address: Russell D. Orkin, 700 Koppers Building, 436 Seventh Avenue, Pittsburg, PA, 15219-1818, US

(73) Assignee: WESTINGHOUSE AIR BRAKE TECHNOLOGIES CORPORATION

(21) Appl. No.: 10/437,514

(22) Filed: May 14, 2003

(51) Int. Cl. G06F 17/00

(52) U.S. Cl. 701/19; 246/167 R

(57) ABSTRACT

The automatic initiation and activation of a locomotive horn with intelligent sequencing requires the ability to determine the global position and speed of a locomotive. It also has the ability to communicate the global position and speed to an onboard database system disposed on the locomotive. The onboard database systems utilizes the global position in conjunction with the speed of the locomotive to determine when to automatically initiate activation of the locomotive horn with a predetermined intelligent sequence.

### FIELD OF INVENTION

The present invention relates, in general, to railroad crossing warning systems, and more particularly to an improved warning system which provides automatic locomotive horn activation with intelligent sequencing for directing sound along an intersecting road with correlation to grade crossings and whistle posts.

### BACKGROUND OF THE INVENTION

Grade crossings and whistle posts, where motor vehicle traffic crosses railroad tracks have been a notorious site for collisions between the motor vehicles and locomotives. Various types of warning systems to warn road traffic of the approach of a locomotive rely on two major warning sources, specifically, an audible signal from a locomotive horn or a visual indicator of the location of the railroad crossing or both.

While the visual indicator at the railroad crossing varies from a pair of cross-bucks to fully automated crossing gates with lights and bells, the first part of the equation is to rely on the timely occurrence of horn blasts from the locomotive. Since the driver of a motor vehicle must have sufficient time to stop at the crossing in response to a warning signal, the horn blast from the locomotive must occur at a sufficient distance from the grade crossing. Problems associated with this are maintaining uniform horn blast durations and a discernable difference between long and short blasts and also guaranteeing that the entire sequence will be executed within the allocated window of time so that the final long blast will begin prior to the locomotive crossing the intersection and continuing until it has crossed through the other side.

### SUMMARY OF THE INVENTION

The present invention provides a method of automatically initiating activation of a locomotive horn with intelligent sequencing wherein the method includes the steps of determining the global position and speed of a locomotive, and communicating the global position and speed to an onboard database system disposed on the locomotive. The determinant of the global position in conjunction with the speed of the locomotive is used to automatically initiate activation of the locomotive horn with a predetermined intelligent sequence.

The present invention also provides an apparatus to automatically initiate activation of a locomotive horn with intelligent sequencing the apparatus comprises an onboard database system disposed in a computer on a locomotive. There is a means disposed on the locomotive for determining a global position of the locomotive, and a means connected between the onboard database system and the locomotive horn to automatically initiate activation of the locomotive horn. The locomotive horn has a predetermined intelligent sequence program disposed in the onboard database system. The activation of this locomotive horn is based on the global position of the locomotive. There is a means connected between the onboard database system and the locomotive horn to automatically initiate activation of the locomotive horn.

### OBJECTS OF THE INVENTION

It is, therefore, one of the primary objects of the present invention to provide automatic locomotive horn activation with intelligent sequencing that activates at every whistle post prior to a grade crossing.

It is also an object of the present invention to provide automatic locomotive horn activation with intelligent sequencing that utilizes a global position system (GPS) to determine locomotive position with correlation to grade crossing and whistle posts.

Another object of the present invention is to provide automatic locomotive horn activation with intelligent sequencing that produces a sound activated at a very high decibel level to be heard by the driver while the locomotive is still approaching an intersection.

Another object of the present invention is to provide automatic locomotive horn activation with intelligent sequencing that is relatively inexpensive to implement.

Yet another object of the present invention is to provide automatic locomotive horn activation with intelligent sequencing that improves safety at intersections.

These and various other objects and advantages of this invention will become more readily apparent to those persons skilled in the art after a full reading of the following detailed description, particularly, when such description is read in conjunction with the attached drawings as described below and the appended claims.

### BRIEF DESCRIPTION OF THE DRAWINGS

FIG. 1 is a block diagram of the presently preferred apparatus to automatically initiate activation of a locomotive horn with intelligent sequencing.

FIG. 2 is a time sequential diagram representing a horn blast pattern with an intelligent sequence.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components, which have identical functions have been designated by identical reference numerals throughout the drawing Figure.

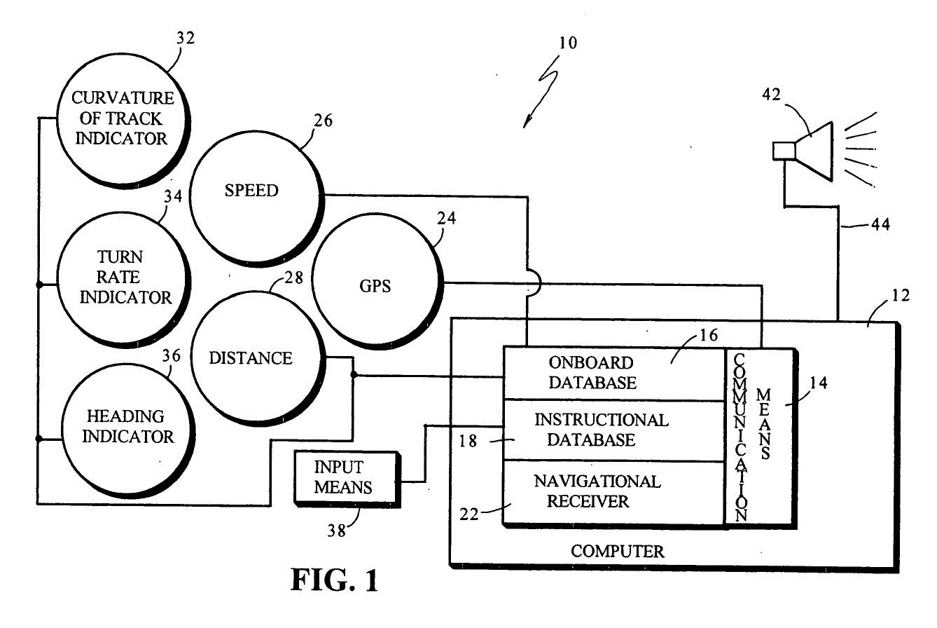

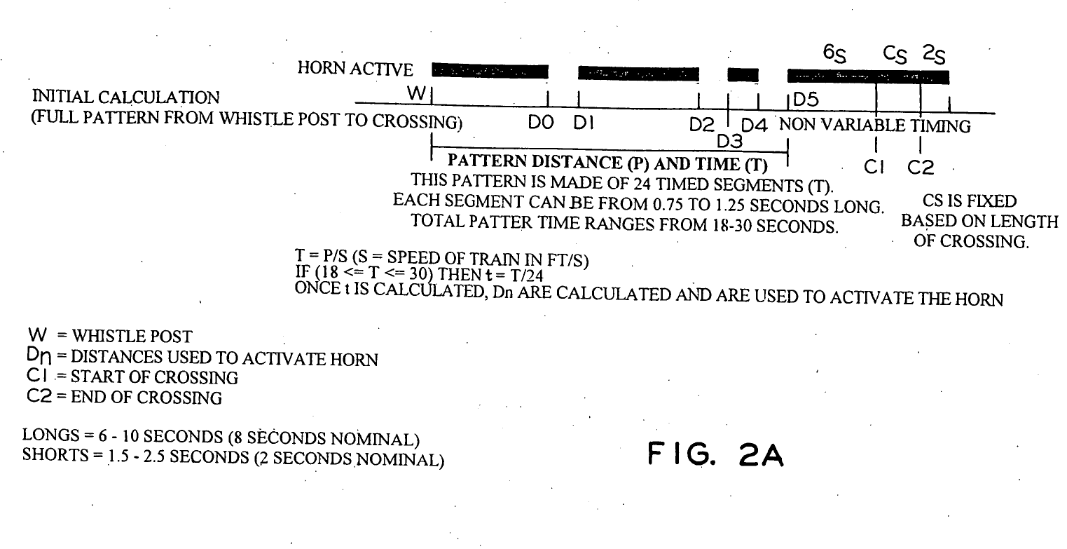

Reference is now made to FIG. 1. Illustrated therein is a presently preferred embodiment of a apparatus for automatically initiating activation of a locomotive horn with intelligent sequencing, generally designated 10, utilizes an onboard database system 16 disposed in a computer 12 on a locomotive (not shown). There is a means 24 disposed on such locomotive for determining a global position of such locomotive. The locomotive also contains a turn rate indicator means 34 used for measuring a rate at which such locomotive turns on a track route and for generating a signal indicative of a turn rate of such locomotive to be communicated to the onboard database system 16. Likewise, there is a curvature of track indicator means 32 used for deriving a curvature of a track route and for generating a signal indicative of the curvature of the track route which such locomotive is traveling to be communicated to the onboard database system 16. Additionally there is a means 26 for determining a speed of such locomotive and for generating a signal indicative of the speed of such locomotive to be communicated to the onboard database system 16. There is also a means 28 disposed on such locomotive for measuring a distance traveled by such locomotive and for generating a signal indicative of the distance traveled by such locomotive to be communicated to the onboard database system 16. Furthermore the locomotive includes a heading indicator means 36 used for indicating a heading of such locomotive on a track route and for generating a signal indicative of the heading of such locomotive to be communicated to the onboard database system 16. Finally, the locomotive includes an input means 38 used for inputting instructional data pertaining to locations and orientations of track routes, switches, grade crossings, whistle posts, and curves in such track system to the onboard database system 16.

The computer 12 contains a communication means 14 connected to the computer 12 and the means 24 for determining said global position of such locomotive for communicating the global position to the onboard database system 16. Also connected to the onboard database system 16 is a means 44 connected between the onboard database system 16 and the locomotive horn 42 to automatically initiate activation of the locomotive horn 42 with a predetermined intelligent sequence program disposed in the onboard database system 16 based on the global position. Also contained in the computer is a navigational receiver 22 for communicating signals to and from the communication means 14 and the onboard database system 16.

The method for automatically initiating activation of a locomotive horn 42 with intelligent sequencing includes the following steps. Determining a global position of a locomotive, and communicating the global position to an onboard database system 16 disposed on the locomotive. Determining a speed of the locomotive, and communicating the speed to the onboard database system 16. Automatically initiating activation of a locomotive horn 42 with a predetermined intelligent sequence program disposed in the onboard database system 16 based on the global position and the locomotive speed communicated.

The onboard database system 16 includes instructional data pertaining to locations and orientations of track routes, switches, grade crossings, whistle posts, and curves in the track system used in conjunction with the global position and speed of the locomotive to determine when to automatically initiate activation of the locomotive horn 42 with intelligent sequencing.

The method further includes the additional steps of measuring a rate at which the locomotive turns on a track route so as to generate a first signal indicative of a turn rate of the locomotive. The method derives a second signal indicative of curvature of the track route on which the locomotive is traveling from the first signal and at least one of a third signal indicative of a locomotive speed and a fourth signal indicative of distance traveled by the locomotive. By comparing the second signal with data pertaining to locations and orientations of at least one of the track routes, switches, grade crossings, whistle posts, or curves in a track system enables a more accurate determination of the global position the locomotive occupies in relation to the track routes, switches, grade crossings, whistle posts, or curves in the track system. Upon completion of this comparison a fifth signal indicative of the global position is generated. The locations and orientations are based on longitude and latitude coordinates.

The onboard database system 16 receives input data that includes a current global position which the locomotive occupies on the track route. It references this current global position in conjunction with a navigational receiver 22 to determine a heading as determined by a heading indicator 36, a third signal indicative of a locomotive speed is generated by a speedometer, a fourth signal indicative of a distance traveled as generated by an odometer, and a rate the locomotive turns on the track route as determined by a turn rate indicator 34.

The navigational receiver 22 also utilizes the third signal indicative of the locomotive speed and the fourth signal indicative of a distance traveled by the locomotive absent braking thereof on a straight section of the track route with which to calibrate a diameter of a wheel of a locomotive for purpose of maintaining accuracy of the fourth signal indicative of the distance traveled.

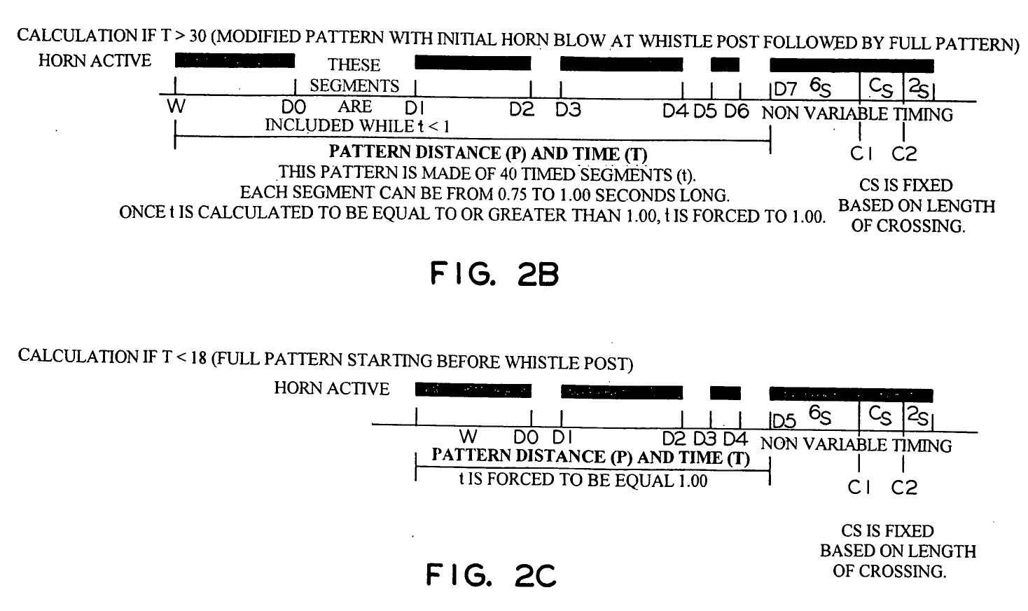

Referring now to FIG. 2 the method for automatically initiating activation of a locomotive horn 42 with intelligent sequencing includes a predetermined horn blast pattern for a predetermined duration. Wherein the predetermined horn blast pattern includes a long-long-short sequence prior to crossing a grade crossing, and a final long blast as the locomotive traverses a grade crossing. The predetermined duration begins at a predetermined time, approximately 30 seconds, prior to the locomotive crossing a grade crossing.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

We claim:

1. A method of automatically initiating activation of a locomotive horn with intelligent sequencing, said method includes the steps of:
a) determining a global position of a locomotive;
b) communicating said global position as determined in step (a) to an onboard database system disposed on said locomotive;
c) determining a speed of said locomotive;
d) communicating said speed as determined in step (c) to said onboard database system;
e) determining when to automatically initiate activation of said locomotive horn with a predetermined intelligent sequence program disposed in said onboard database system based on said global position communicated in step (b) and said locomotive speed communicated in step (d); and
f) automatically initiating said locomotive horn with said predetermined intelligent sequence program disposed in said onboard database system on said locomotive.

2. A method of automatically initiating activation of a locomotive horn with intelligent sequencing, according to claim 1, wherein said predetermined intelligent sequence includes a predetermined horn blast pattern for a predetermined duration.

3. A method of automatically initiating activation of a locomotive horn with intelligent sequencing, according to claim 1, wherein said onboard database includes instructional data pertaining to locations and orientations of at least one of (i) track routes, (ii) switches, (iii) grade crossings, (iv) whistle posts, and (v) curves in such track system.

4. A method of automatically initiating activation of a locomotive horn with intelligent sequencing, according to claim 2, wherein said predetermined horn blast pattern includes a long-long-short sequence prior to crossing a grade crossing, and a final long blast as said locomotive traverses a grade crossing.

5. A method of automatically initiating activation of a locomotive horn with intelligent sequencing, according to claim 2, wherein said predetermined duration begins at a predetermined time prior to said locomotive crossing a grade crossing.

6. A method of automatically initiating activation of a locomotive horn with intelligent sequencing, according to claim 3, wherein said method includes the additional steps of:
a) measuring a rate at which said locomotive turns on said track route so as to generate a first signal indicative of a turn rate of said locomotive;
b) deriving a second signal indicative of curvature of said track route on which said locomotive is traveling from said first signal and at least one of a third signal indicative of a locomotive speed and a fourth signal indicative of distance traveled by said locomotive;
c) comparing said second signal with said data pertaining to said locations and orientations of said at least one of said track routes, said switches, said grade crossings, said whistle posts, and said curves in such track system to more accurately determine said global position said locomotive occupies in relation to said at least one of said track routes, said switches, said grade crossings, said whistle posts, and said curves in such track system; and
d) generating a fifth signal indicative of said global position thereof.

7. A method of automatically initiating activation of a locomotive horn with intelligent sequencing, according to claim 5, wherein said predetermined time is about 30 seconds

8. A method of automatically initiating activation of a locomotive horn with intelligent sequencing, according to claim 6, wherein said onboard database uses a navigational receiver to determine at least one of:
a) a heading of said locomotive on said track route;
b) said third signal indicative of a locomotive speed of said locomotive;
c) said forth signal indicative of a distance traveled by said locomotive; and
d) said rate at which said locomotive turns on said track route.

9. A method of automatically initiating activation of a locomotive horn with intelligent sequencing, according to claim 6, wherein step (c) further includes entering input into said onboard database, said input at least including a current global position said locomotive occupies on said track route.

10. A method of automatically initiating activation of a locomotive horn with intelligent sequencing, according to claim 6, wherein said third signal indicative of said locomotive speed of is said locomotive is generated by a speedometer.

11. A method of automatically initiating activation of a locomotive horn with intelligent sequencing, according to claim 6, wherein said fourth signal indicative of said distance traveled by said locomotive is generated by an odometer.

12. A method of automatically initiating activation of a locomotive horn with intelligent sequencing, according to claim 8, wherein said heading is generated by a heading indicator means.

13. A method of automatically initiating activation of a locomotive horn with intelligent sequencing, according to claim 8, wherein said method includes using said navigational receiver to determine said third signal indicative of said locomotive speed and said fourth signal indicative of said distance traveled by said locomotive absent braking thereof on a straight section of said track route with which to calibrate a diameter of such wheel of said locomotive for purpose of maintaining accuracy of said fourth signal indicative of said distance traveled.

14. A method of automatically initiating activation of a locomotive horn with intelligent sequencing, according to claim 9, wherein said method includes utilizing said current global position in conjunction with said third signal indicative of said locomotive speed to determine when said locomotive will automatically activate said horn as said locomotive travels through predetermined longitude and latitude coordinates.

15. A method of automatically initiating activation of a locomotive horn with intelligent sequencing, according to claim 14, wherein said predetermined longitude and latitude coordinates correspond to at least one of a whistle post and a grade crossing.

16. An apparatus to automatically initiate activation of a locomotive horn with intelligent sequencing, said apparatus comprising:
a) an onboard database system disposed in a computer on a locomotive;
b) a means disposed on such locomotive for determining a global position of such locomotive;
c) a communication means connected to said computer and said means for determining said global position of such locomotive for communicating said global position to said onboard database system; and
d) a means connected to said onboard database system and to such locomotive horn to automatically initiate activation of such locomotive horn with a predetermined intelligent sequence program disposed in said onboard database system based on said global position.

17. An apparatus to automatically initiate activation of a locomotive horn with intelligent sequencing, according to claim 16, wherein said apparatus further includes a navigational receiver disposed in said computer for communicating signals to and from said communication means and said onboard database system.

18. An apparatus to automatically initiate activation of a locomotive horn with intelligent sequencing, according to claim 16, wherein said apparatus further includes a turn rate indicator means disposed on such locomotive for measuring a rate at which such locomotive turns on a track route and for generating a signal indicative of a turn rate of such locomotive to be communicated to said onboard database system.

19. An apparatus to automatically initiate activation of a locomotive horn with intelligent sequencing, according to claim 16, wherein said apparatus further includes a curvature of track indicator means disposed on such locomotive for deriving a curvature of a track route and for generating a signal indicative of said curvature of said track route which such locomotive is traveling to be communicated to said onboard database system.

20. An apparatus to automatically initiate activation of a locomotive horn with intelligent sequencing, according to claim 16, wherein said apparatus further includes a means disposed on such locomotive for determining a speed of such locomotive and for generating a signal indicative of said speed of such locomotive to be communicated to said onboard database system.

21. An apparatus to automatically initiate activation of a locomotive horn with intelligent sequencing, according to claim 16, wherein said apparatus further includes a means disposed on such locomotive for measuring a distance traveled by such locomotive and for generating a signal indicative of said distance traveled by such locomotive to be communicated to said onboard database system.

22. An apparatus to automatically initiate activation of a locomotive horn with intelligent sequencing, according to claim 16, wherein said apparatus further includes a heading indicator means disposed on such locomotive for indicating a heading of such locomotive on a track route and for generating a signal indicative of said heading of such locomotive to be communicated to said onboard database system.

23. An apparatus to automatically initiate activation of a locomotive horn with intelligent sequencing, according to claim 16, wherein said apparatus further includes an input means disposed on such locomotive for inputting instructional data pertaining to locations and orientations of at least one of (i) track routes, (ii) switches, (iii) grade crossings, (iv) whistle posts, and (v) curves in such track system to said onboard database system.
